(19) United States
(12) Patent Application Publication
(10) Pub. No.: US 2012/0182271 A1
(43) Pub. Date: Jul. 19, 2012

(54) DIGITAL PAINTING PEN, DIGITAL PAINTING SYSTEM AND MANIPULATING METHOD THEREOF

(76) Inventors: Fong-Gong Wu, Tainan City (TW); Tai-Hua Lee, Taipei County (TW); Hui-Tsz Chen, Taoyuan County (TW); Ya-San Fong, Taichung City (TW); Chia-Jung Tsai, Kaohsiung City (TW); Meng-Long Wu, Changhua County (TW); Li-Ru Lai, Taichung County (TW); Tsai-Fang Wu, Tainan City (TW)

(21) Appl. No.: 13/110,576

(22) Filed: May 18, 2011

(30) Foreign Application Priority Data
Jan. 13, 2011 (CN) 201110006200.4

(51) Int. Cl. G06F 3/033

(52) U.S. Cl. 345/179

(57) ABSTRACT

A digital painting pen includes a pen body and at least one sensor, which is disposed on the pen body and generates at least one sensing signal according to a condition while a user rotates or presses the digital painting pen, changes an angle of the digital painting pen against a plane, changes a holding position of the digital painting pen, or slides a finger to change a position of the finger on the digital painting pen, thereby changing a color, a brush type or a brush thickness of the digital painting pen. Accordingly, the present invention can change a color, a brush type and a brush thickness of the digital painting pen to achieve an instinctive drawing effect without using buttons and switches.

### BACKGROUND OF THE INVENTION

1. Field of Invention

The present invention relates to a digital pen, and, in particular, to a digital painting pen.

2. Related Art

Conventionally, when a drawing process is to be performed, various pen tools, such as the color, the brush type, the brush thickness and the like, have to be prepared in advance, and a lot of the pen tools have to be prepared according to the multiplication result. The painting pen has to be continuously replaced, and the colors have to be mixed to complete the drawings.

Recently, with the progress of the technology, the drawing process does not need so many preparing works. All pen tools are integrated into an electronic painting pen by the technology to complete the drawing process without the complicated operations of replacing the painting pen or mixing the color.

However, the color, the brush type or the brush thickness has to be changed through the switches, buttons or a series of settings.

Therefore, it is an important subject of the present invention to provide a digital painting pen so that the user can change the color, the brush type or the brush thickness of the digital painting pen through an instinctive body-sense operation method without the switches, buttons or a series of settings.

### SUMMARY OF THE INVENTION

It is therefore an object of the present invention to provide a digital painting pen, a digital painting system and its manipulating method, so that the user can change the color, the brush type or the brush thickness of the digital painting pen through the instinctive body-sense operation method without the switches, buttons or a series of settings.

To achieve the above, the present invention discloses a digital painting pen includes a pen body and at least one sensor, which is disposed on the pen body and generates at least one sensing signal according to a condition while a user rotates or presses the digital painting pen, changes an angle of the digital painting pen against a plane, changes a holding position of the digital painting pen, or slides a finger to change a position of the finger on the digital painting pen, thereby changing a color, a brush type or a brush thickness of the digital painting pen.

In one embodiment of the present invention, the sensor may be an angle sensor, an acceleration sensor, a stress sensor, an optical sensor, a center-of-gravity sensor or a combination thereof. Apply different sensor or their combination can broaden the scope of application.

In one embodiment of the present invention, the digital painting pen without a physical switch or button for changing the color, the brush type or the brush thickness of the digital painting pen.

To achieve the above, the present invention discloses a digital painting system includes a processing module and a digital painting pen. The digital painting pen includes a pen body, a transmission unit and at least one sensor. The transmission unit and the sensor are disposed on the pen body. The sensor generates at least one sensing signal according to a condition while a user rotates or presses the digital painting pen, changes an angle of the digital painting pen against a plane, changes a holding position of the digital painting pen, or slides a finger to change a position of the finger on the digital painting pen, wherein the sensing signal is transmitted to the processing module through the transmission unit, thereby changing a color, a brush type or a brush thickness of the digital painting pen.

In one embodiment of the present invention, the sensor may be an angle sensor, an acceleration sensor, a stress sensor, an optical sensor, a center-of-gravity sensor or a combination thereof.

In one embodiment of the present invention, the digital painting pen without a physical switch or button for changing the color, the brush type or the brush thickness of the digital painting pen.

In one embodiment of the present invention, the processing module is connected to a display screen.

To achieve the above, the present invention discloses a manipulating method of a digital painting pen including the steps of: making a user use one hand to hold the digital painting pen; and rotating or pressing the digital painting pen, changing an angle of the digital painting pen against a plane, changing a holding position of the digital painting pen, or sliding a finger to change a position of the finger on the digital painting pen to change a color, a brush type or a brush thickness of the digital painting pen.

In one embodiment of the present invention, the digital painting pen without a physical switch or button for changing the color, the brush type or the brush thickness of the digital painting pen.

To achieve the above, the present invention discloses a manipulating method of a digital painting system, wherein the digital painting system includes a processing module and a digital painting pen. The manipulating method includes the steps of: making a user to use one hand to hold the digital painting pen; rotating or pressing the digital painting pen, changing an angle of the digital painting pen against a plane, changing a holding position of the digital painting pen or sliding a finger to change a position of the finger on the digital painting pen to change a color, a brush type or a brush thickness of the digital painting pen; and making the digital painting pen contact a display screen when the color, the brush type or the brush thickness of the digital painting pen is selected, such that the processing module controls the display screen to display according to the color, the brush type or the brush thickness.

As mentioned above, the digital painting pen, the digital painting system and the manipulating method of the present invention have the following advantages. The user can perform the body-sense operation by rotating or pressing the digital painting pen, changing an angle of the digital painting pen against a plane, changing the holding position of the digital painting pen, or sliding the finger to change the position of the finger on the digital painting pen to change the color, brush type or brush thickness of the digital painting pen without using buttons and switches, so that the instinctive drawing effect can be achieved.

### BRIEF DESCRIPTION OF THE DRAWINGS

The present invention will become more fully understood from the detailed description given herein below illustration only, and thus is not limitative of the present invention, and wherein:

FIG. 1 is a schematic diagram showing a digital painting pen according to a preferred embodiment of the present invention;

FIGS. 2A to 2D are schematic diagrams showing the use of the digital painting pen of the present invention;

FIG. 3 is a block diagram showing a digital painting system according to the preferred embodiment of the present invention;

FIG. 4 is a flow chart showing a manipulating method of the digital painting pen according to the preferred embodiment of the present invention; and

FIG. 5 is a flow chart showing a manipulating method of the digital painting system according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

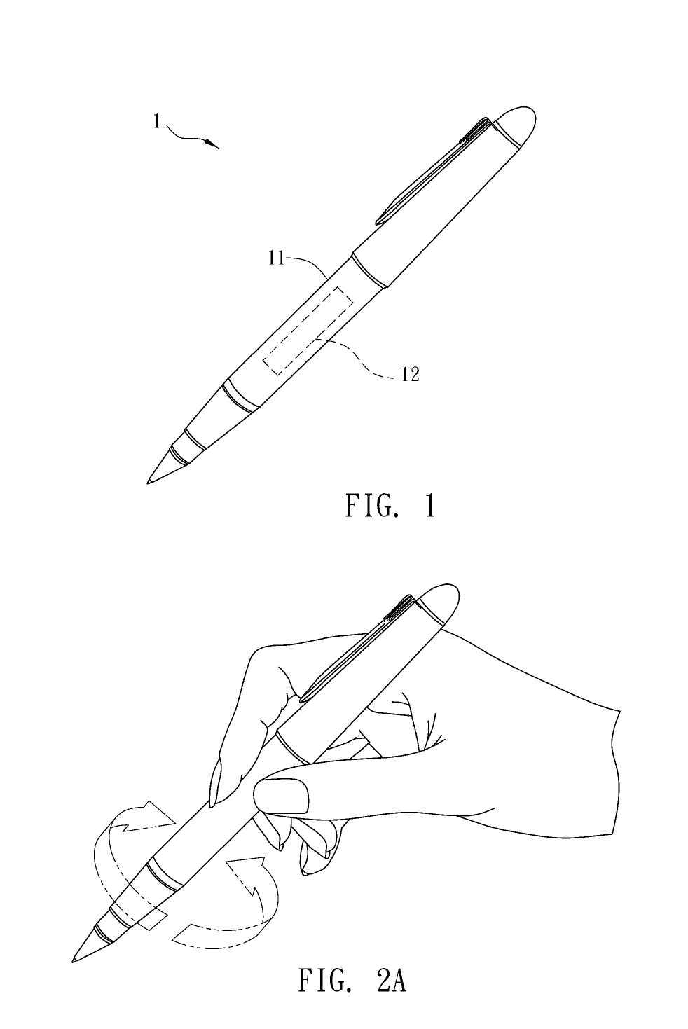

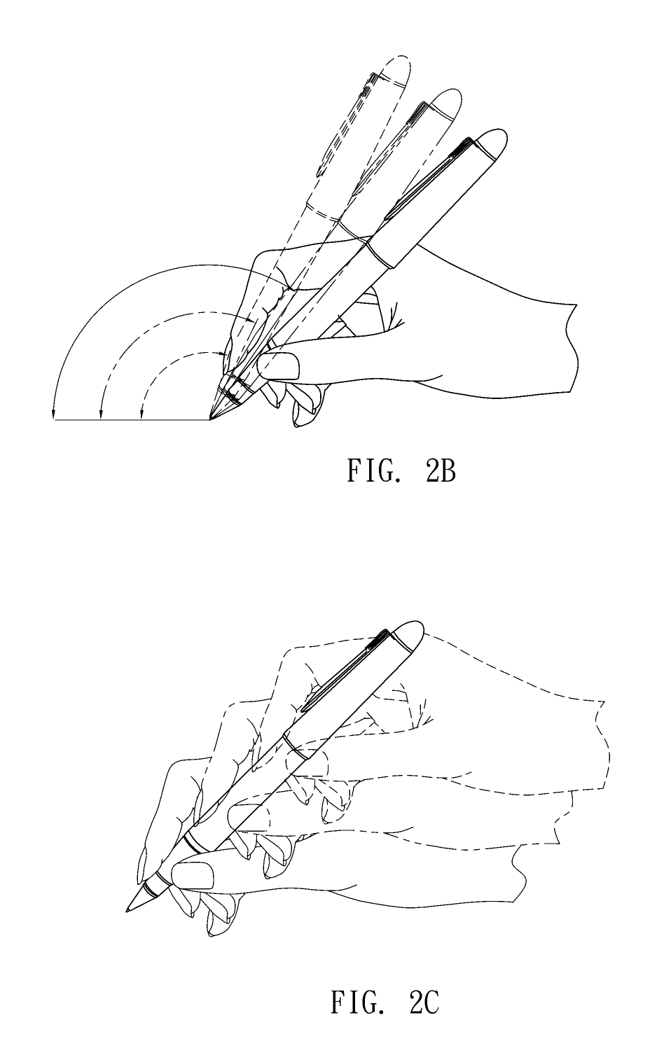

FIG. 1 is a schematic diagram showing a digital painting pen 1 according to a preferred embodiment of the present invention. FIGS. 2A to 2D are schematic diagrams showing the use of the digital painting pen 1 of the present invention. Referring to FIG. 1, the digital painting pen 1 of this embodiment includes a pen body 11 and at least one sensor 12. In this embodiment, the digital painting pen 1 has no physical switch or button for changing a color, a brush type, a brush thickness or a combination thereof of the digital painting pen 1.

The sensor 12 is disposed on the pen body 11 and may be an angle sensor, an acceleration sensor, a stress sensor, an optical sensor, a center-of-gravity sensor or a combination thereof. At least one sensing signal is generated by rotating or pressing the digital painting pen 1, changing an angle of the digital painting pen 1 against a plane, changing a holding position of the digital painting pen 1, or sliding a finger to change a position of the finger on the digital painting pen 1, thereby changing the color, the brush type or the brush thickness of the digital painting pen 1.

As shown in FIG. 2A, when the user rotates the digital painting pen 1, the sensor generates a sensing signal according to the rotated angle. The sensor may be the angle sensor, such as a gyroscope, disposed at an arbitrary position of the pen body. The sensor may be the acceleration sensor, and the angle information can be obtained by way of integration. The user can rotate the digital painting pen 1 to different azimuths to change the color, the brush type or the brush thickness of the digital painting pen 1, especially for the application of changing the brush thickness of the digital painting pen 1, this concept originates from the conditions that the cross-sectional area of the crayon is enlarged after the child uses the crayon to draw for a long time, and that the crayon can be rotated to select the pen brush with the large cross-sectional area. This embodiment can be used in conjunction with the pentagonal pen brush head to obtain five different brush thicknesses by rotating the pen body.

In addition, when the user presses the digital painting pen 1, the sensor can generate a sensing signal according to the stress. The sensor may be, for example, a stress sensor, disposed near one end of the nib, for effectively sensing the stress. The force of the user for pressing the digital painting pen 1 can be adjusted to change the color, the brush type or the brush thickness of the digital painting pen 1. For example, when being applied to change the brush type, three different options, including the pencil, the crayon and the watercolor pen, may be selected.

As shown in FIG. 2B, when the user changes the angle of the digital painting pen 1 against a plane, the sensor can generate a sensing signal according to the angle. The sensor may be, for example, a center-of-gravity sensor. When the angle of the digital painting pen 1 against the plane changes, the sensor of gravity also changes. So, the center-of-gravity sensor may be used to sense, and the center-of-gravity sensor may be disposed at the middle of the pen body. The sensor may be, for example, an acceleration sensor, such as a G sensor. The sensor may be, for example, an angle sensor. The above-mentioned elements may also be used to sense the azimuth of the digital painting pen 1. The acceleration sensor and the angle sensor may be disposed on one end away from the nib. The user can change the angle of the digital painting pen 1 against a plane to change the color, the brush type or the brush thickness of the digital painting pen 1, especially for the application of changing the brush thickness. This concept originates from that the angle of the pen head can be changed to generate the pen brushes with different widths according to the different tilt angles.

As shown in FIG. 2C, when the user changes the holding position of the digital painting pen 1, the sensor can generate a sensing signal according to the holding position. The sensor may be, for example, an optical sensor, which may be disposed at the middle of the pen body and can sense different holding positions by obstructing the light rays absorbed by the optical sensor. In addition, the digital painting pen 1 may also have a plurality of optical sensors for performing diversified switching operations. The sensor may also be a stress sensor. When the holding position changes, the stress sensor located at the same position, such as the middle of the pen body, senses the stress change so that the switching operation can be performed. The sensor may also be an angle sensor, an acceleration sensor or a center-of-gravity sensor. When the user changes the holding position of the digital painting pen 1, the pen body is also tilted. So, the above-mentioned element may be applied to sense the tilt angle of the pen body. When the user changes the holding position of the digital painting pen 1, the color, brush type or brush thickness of the digital painting pen 1 can be changed, especially for the application of changing the brush type. The concept originates from that when the child uses different pen brush tools, the child exerts different forces upon the pen brushes with different hardnesses, and makes the pen body have different tilt angles.

As shown in FIG. 2D, when the user slides the finger to change the position of the finger on the digital painting pen 1, the sensor can generate a sensing signal according to the position change of the finger. The sensor may be, for example, at least one optical sensor, which is disposed at the middle of the pen body, and senses the position of the finger when the user slides the finger to obstruct the light rays absorbed by the optical sensor. According to the position change of the user's finger, the color, brush type or brush thickness of the digital painting pen 1 can be changed. For example, in the application of changing the color, a color table may be disposed on the pen body, and the user may slide the finger to select the desired color.

The types and positions of the sensors are only for the illustrative but non-restrictive purpose. The present invention can use the above-mentioned elements or a combination thereof to achieve the effect of changing the color, brush type, brush thickness or any other property.

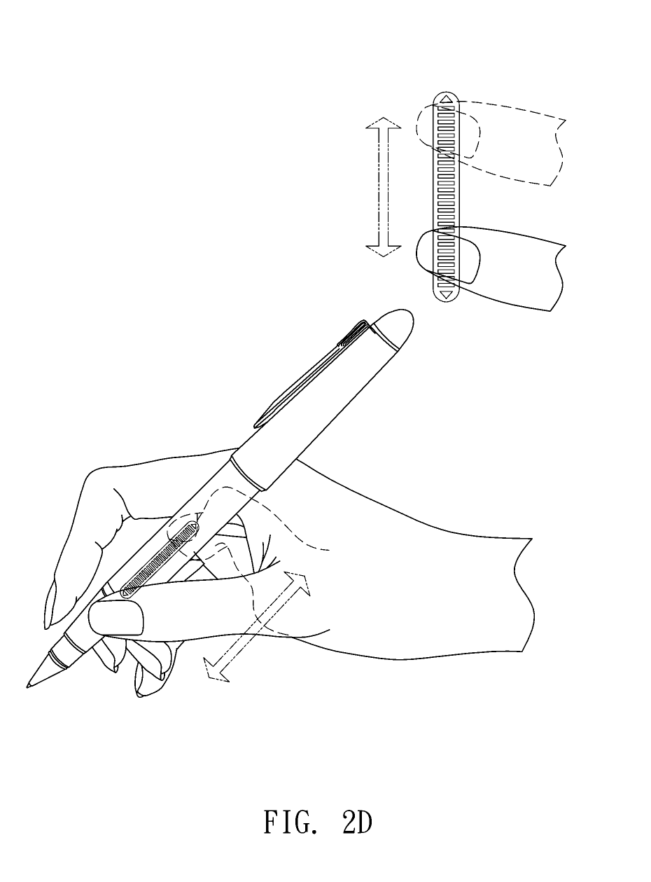

FIG. 3 is a block diagram showing a digital painting system 2 according to the preferred embodiment of the present invention. Referring to FIG. 3, the digital painting system 2 of this embodiment includes a digital painting pen 1 and a processing module 22. The digital painting pen 1 further includes a transmission unit 13, wherein the other electronic parts have been described in the first preferred embodiment, and detailed descriptions thereof will be omitted. The transmission unit 13 is disposed on the pen body 11, and receives a sensing signal and transmits the sensing signal to the processing module 22. The digital painting system further includes a display screen 23 connected to the processing module 22. The processing module 22 receives the sensing signal, thereby changing the color, brush type or brush thickness of the digital painting pen 1. The display screen 23 and the processing module 22 may be integrated inside one member, such as a tablet computer.

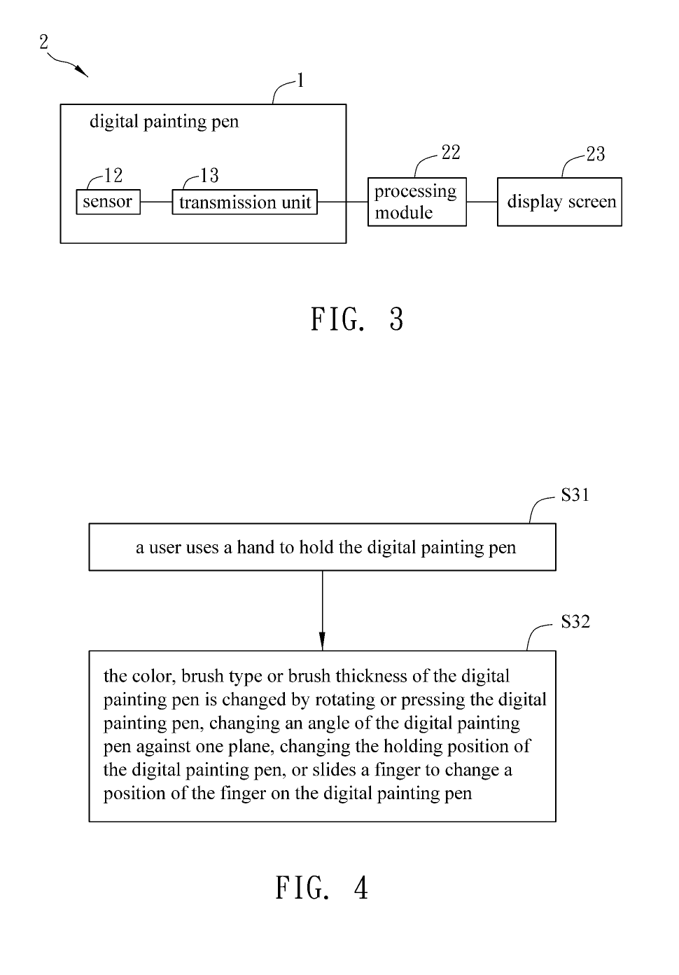

FIG. 4 is a flow chart showing a manipulating method of the digital painting pen 1 according to the preferred embodiment of the present invention. The manipulating method includes steps S31 to S32. In the step S31, a user uses a hand to hold the digital painting pen 1. In the step S32, the color, brush type or brush thickness of the digital painting pen 1 is changed by rotating or pressing the digital painting pen 1, changing an angle of the digital painting pen 1 against one plane, changing the holding position of the digital painting pen 1, or slides a finger to change a position of the finger on the digital painting pen 1. In addition, the digital painting pen 1 has no physical switch or button for changing the color, brush type or brush thickness of the digital painting pen 1.

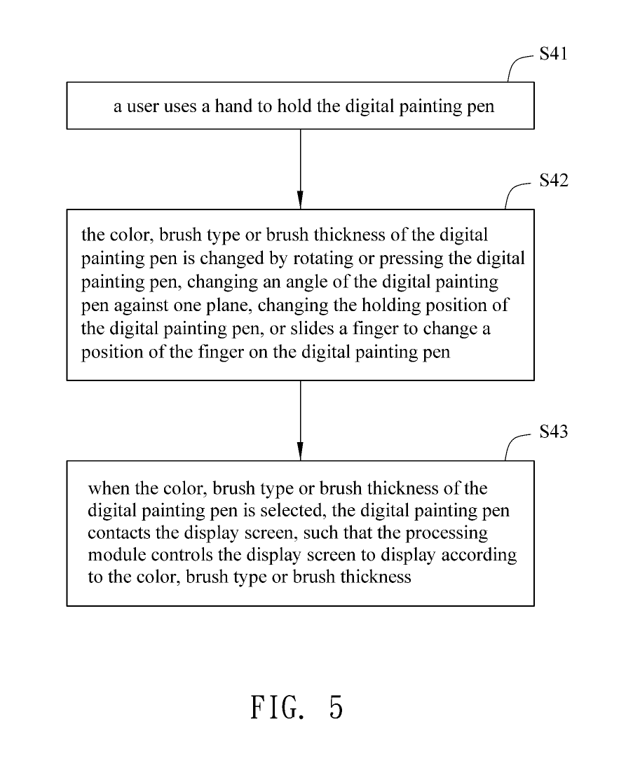

FIG. 5 is a flow chart showing a manipulating method of the digital painting system 2 according to the preferred embodiment of the present invention. Referring to FIG. 5, the manipulating method includes steps S41 to S43. The steps S41 and S42 have been described in detail in the steps S31 and S32, and detailed descriptions thereof will be omitted. In the step S43, when the color, brush type or brush thickness of the digital painting pen 1 is selected, the digital painting pen 1 contacts the display screen 23, such that the processing module 22 controls the display screen 23 to display according to the color, brush type or brush thickness.

To sum up, the digital painting pen, the digital painting system and the manipulating method of the present invention have the following advantages. The user can perform the body-sense operation by rotating or pressing the digital painting pen, changing an angle of the digital painting pen against a plane, changing the holding position of the digital painting pen, or sliding the finger to change the position of the finger on the digital painting pen to change the color, brush type or brush thickness of the digital painting pen without using buttons and switches, so that the instinctive drawing effect can be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A digital painting pen, comprising:
a pen body; and
at least one sensor, which is disposed on the pen body and generates at least one sensing signal according to a condition while a user rotates or presses the digital painting pen, changes an angle of the digital painting pen against a plane, changes a holding position of the digital painting pen, or slides a finger to change a position of the finger placed on the digital painting pen, thereby changing a color, a brush type or a brush thickness of the digital painting pen.

2. The digital painting pen according to claim 1, wherein the sensor is an angle sensor, an acceleration sensor, a stress sensor, an optical sensor, a center-of-gravity sensor or a combination thereof.

3. The digital painting pen according to claim 1 without a physical switch for changing the color, the brush type or the brush thickness of the digital painting pen.

4. A digital painting system, comprising:
a processing module; and
a digital painting pen, which comprises:
a pen body;
a transmission unit disposed on the pen body; and
at least one sensor, which is disposed on the pen body and generates at least one sensing signal according to a condition while a user rotates or presses the digital painting pen, changes an angle of the digital painting pen against a plane, changes a holding position of the digital painting pen, or slides a finger to change a position of the finger on the digital painting pen, wherein the sensing signal is transmitted to the processing module through the transmission unit, thereby changing a color, a brush type or a brush thickness of the digital painting pen.

5. The digital painting system according to claim 4, wherein the sensing element is an angle sensor, an acceleration sensor, a stress sensor, an optical sensor, a center-of-gravity sensor or a combination thereof.

6. The digital painting system according to claim 4, wherein the digital painting pen without a physical switch for changing the color, the brush type or the brush thickness of the digital painting pen.

7. The digital painting system according to claim 4, wherein the processing module is connected to a display screen.

8. A manipulating method of a digital painting pen, the manipulating method comprising the steps of:
making a user use one hand to hold the digital painting pen; and
rotating or pressing the digital painting pen, changing an angle of the digital painting pen against a plane, changing a holding position of the digital painting pen, or sliding a finger to change a position of the finger on the digital painting pen to change a color, a brush type or a brush thickness of the digital painting pen.

9. The manipulating method according to claim 8, wherein the digital painting pen without a physical switch for changing the color, the brush type or the brush thickness of the digital painting pen.

10. A manipulating method of a digital painting system, the digital painting system comprising a processing module and a digital painting pen, the manipulating method comprising the steps of:
making a user to use one hand to hold the digital painting pen;
rotating or pressing the digital painting pen, changing an angle of the digital painting pen against a plane, changing a holding position of the digital painting pen or sliding a finger to change a position of the finger on the digital painting pen to change a color, a brush type or a brush thickness of the digital painting pen; and
making the digital painting pen contact a display screen when the color, the brush type or the brush thickness of the digital painting pen is selected, such that the processing module controls the display screen to display according to the color, the brush type or the brush thickness.
